(19) United States
(12) Patent Application Publication
(10) Pub. No.: US 2011/0157614 A1
(43) Pub. Date: Jun. 30, 2011

(54) IMAGE PROCESSING METHOD AND IMAGE PROCESSING APPARATUS

(75) Inventors: KENJI UEDA, Komae-shi (JP); Kenji Hatakeyama, Kasukabe-shi (JP); Hirofumi Narita, Kawasaki-shi (JP); Yasukazu Ono, Kashiwa-shi (JP)

(73) Assignee: Canon Finetech Inc., Saitama-ken (JP)

(21) Appl. No.: 12/960,598

(22) Filed: Dec. 6, 2010

(30) Foreign Application Priority Data
Dec. 25, 2009 (JP) 2009-295864
Oct. 19, 2010 (JP) 2010-234808

(51) Int. Cl. G06F 15/00

(52) U.S. Cl. 358/1.9

(57) ABSTRACT

This invention provides an image processing method and image processing apparatus, which allow the user to select an image for which an amount of printing material applied to a printing medium is to be reduced. To an object selected on a selection window, a CPU applies image processing for reducing a printing material to data of an internal part of the selected object except for its contour using a program of a printer driver. Then, this invention can provide an image processing method and image processing apparatus, which are convenient for the user.

### BACKGROUND OF THE INVENTION

1. Field of the Invention

The present invention relates to an image processing method and image processing apparatus, which reduce an amount of printing material applied to a printing medium.

2. Description of the Related Art

Conventionally, an image processing apparatus has been proposed that reduces an amount of printing material applied to a printing medium by executing processing for thinning out an internal part other than a contour part of an image while leaving the contour part unchanged, so as to print as many images as possible using the same amount of printing material has been proposed (see Japanese Patent Laid-Open No. 2003-233224). This processing leaves the contour part of an image unchanged, thus suppressing an image visibility drop.

In case the user selects such a printing material reducing mode, the conventional image processing apparatus uniformly reduces the density of the entire image as a target. However, an image often includes partial images of different attributes such as “text”, “line”, “rectangle”, and “bitmap”. In case the uniform printing material reduction processing is applied to these partial images, a partial image to which the user does not want to apply printing material reduction processing may also be processed. For this reason, in case an image includes a partial image to which the user does not want to apply printing material reduction processing, he or she cannot execute the printing material reduction mode even in case another portion includes a partial image for which the user wants to reduce an amount of printed material. That is, the user has to set to uniformly skip the printing material reduction processing for the entire image. That is, since the user can only select whether or not to uniformly apply the printing material reduction processing to a partial image, the conventional apparatus is not convenient for the user.

### SUMMARY OF THE INVENTION

The present invention enables realization of an image processing method and image processing apparatus, which allow the user to select an image for which an amount of printing material applied to a printing medium is to be reduced.

One aspect of the present invention provides an image processing method for processing an entire image including a plurality of partial images, comprising the step of: selecting whether or not to execute a printing material reducing mode for reducing an amount of printing material applied to a printing medium; designating a partial image for which the printing material reducing mode is executed in case the printing material reducing mode is selected; applying image processing for reducing a printing material based on predetermined reduction data to data corresponding to an internal part except for a contour of the partial image designated in the designating step; and outputting data corresponding to the entire image including the partial image processed in the applying step.

Another aspect of the present invention provides an image processing apparatus for processing an entire image including a plurality of partial images, comprising: a mode selection unit that selects whether or not to execute a printing material reducing mode for reducing an amount of printing material applied to a printing medium; an image designation unit that designates a partial image for which the printing material reducing mode is executed in case the mode selection unit selects the printing material reducing mode; a processing unit that applies image processing for reducing a printing material based on predetermined reduction data to data corresponding to an internal part except for a contour of the partial image designated by the image designation unit; and a data output unit that outputs data corresponding to the entire image including the partial image processed by the processing unit, wherein in case the mode selection unit selects not to execute the printing material reducing mode, the processing unit does not execute the image processing of the plurality of partial images.

Further features of the present invention will be apparent from the following description of exemplary embodiments with reference to the attached drawings.

### BRIEF DESCRIPTION OF THE DRAWINGS

FIG. 1 is a block diagram of an image forming system including an image processing apparatus according to an embodiment of the present invention;

FIG. 2 shows a screen example in case layout data for one page, which is created by a program of a layout data creation unit, is displayed;

FIG. 3 is a view showing rectangles, the internal parts of which undergo density conversion, and which are printed on a printing medium by an image forming unit;

FIG. 4 is a diagram showing processing for converting objects into rendering data, and sending these data to an image forming apparatus;

FIG. 5 shows a screen example in case a screen that prompts the user to select whether or not to execute a printing material reducing mode for reducing an amount of using a printing material is displayed;

FIG. 6 is a flowchart of processing for creating rendering data in an information processing apparatus 100;

FIG. 7 is a flowchart for executing printing material reduction rectangular filling processing;

FIG. 8 is a flowchart showing the sequence for executing normal rectangular filling processing;

FIGS. 9A and 9B are flowcharts showing the sequence for executing the printing material reduction rectangular filling processing;

FIG. 10 is a flowchart showing the sequence for executing normal 1-line rendering data generation processing in a rectangle;

FIG. 11 is a flowchart showing the sequence for executing printing material-reduced 1-line rendering data generation processing in a rectangle;

FIG. 12 is a view showing a state in which text is rendered on a rendering area;

FIG. 13 is a flowchart showing the sequence for executing normal filling processing of text, line, and bitmap objects;

FIG. 14 is a flowchart showing the sequence for executing printing material reduction filling processing of text, line, and bitmap objects;

FIGS. 15A and 15B are views showing pattern examples upon execution of thinning processing;

FIGS. 16A and 16B are flowcharts showing the sequence for executing the printing material reduction rectangular filling processing;

FIG. 17 is a flowchart showing the sequence for executing normal C-line rendering data generation processing in a rectangle; and

FIGS. 18A and 18B are flowcharts showing the sequence for executing printing material reducing N-line rendering data generation processing in a rectangle.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

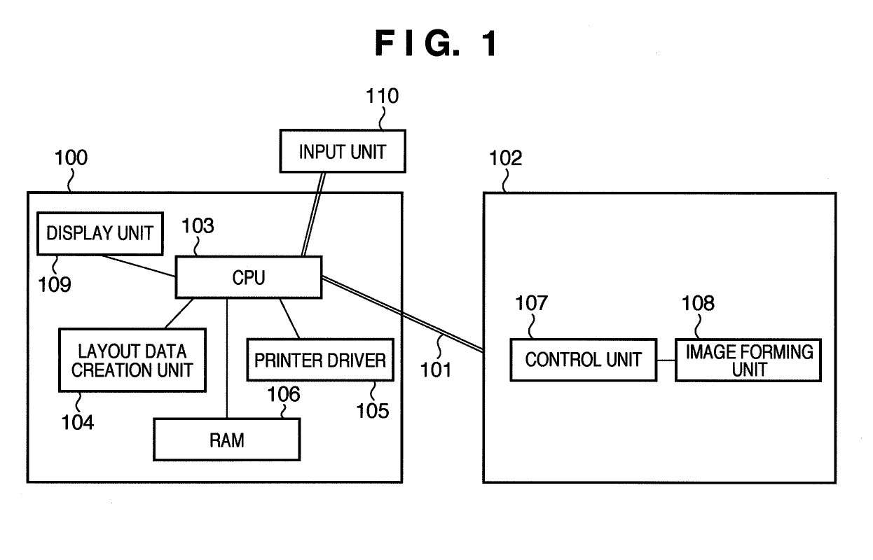

Embodiments of the present invention will now be described in detail with reference to the drawings. FIG. 1 is a block diagram of an image forming system including an image processing apparatus according to an embodiment of the present invention. An information processing apparatus 100 as an image processing apparatus includes a CPU 103 (processing unit) which controls the information processing apparatus 100, and a communication interface 101 (data output unit). The CPU 103 is connected to an image forming apparatus 102 via the communication interface 101. The communication interface 101 adopts, for example, USB (Universal Serial Bus), IEEE1394, and a network (10/100/1000BaseT). In this embodiment, a wired type communication interface 101 is used. Alternatively, a wireless type communication interface 101 such as a wireless LAN may be used.

A layout data creation unit 104 stores a program used to create layout data to be printed by the image forming apparatus 102, and is connected to the CPU 103. The CPU 103 executes the layout data creation unit 104 to create layout data. A printer driver 105 stores a program used to convert layout data created by the program of the layout data creation unit 104 into rendering data that the image forming apparatus 102 can interpret, and is connected to the CPU 103. The printer driver 105 also stores a program used to execute density conversion and thinning processing of objects (partial images) which form layout data (entire image; to be described later) as the program used to convert the layout data into rendering data. The CPU 103 executes the printer driver 105 to convert layout data into rendering data that the image forming apparatus 102 can interpret.

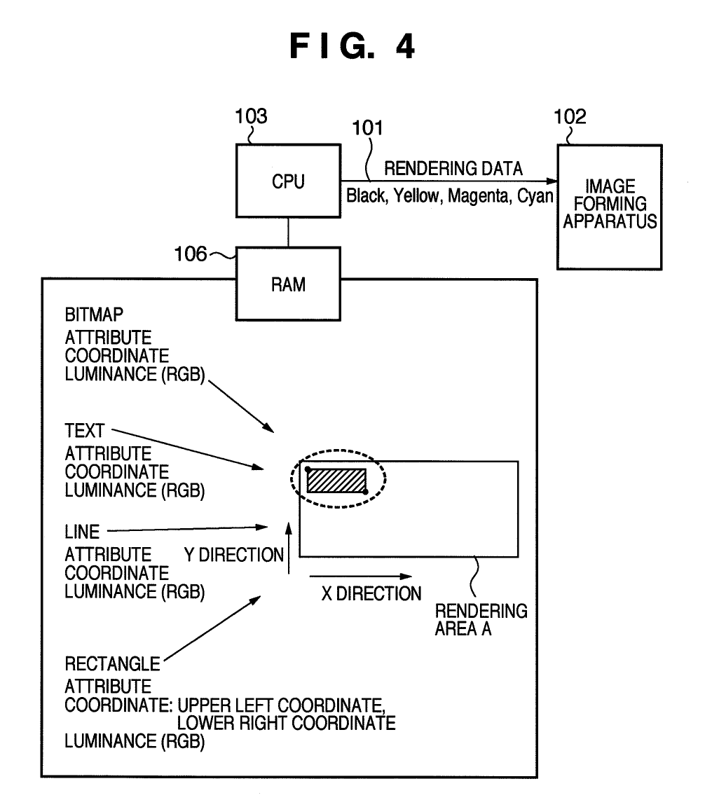

A RAM 106 is used as a main memory of the CPU 103, and a work area such as a rendering area A (see FIG. 4), as will be described later.

The image forming apparatus 102 includes a control unit 107 and image forming unit 108. The control unit 107 of the image forming apparatus 102 interprets the rendering data received from the information processing apparatus 100 to generate a print image, and sends this print image to the image forming unit 108. Then, the image forming unit 108 prints the received print image on a predetermined printing medium. The image forming unit 108 may adopt an ink-jet type image forming apparatus which forms an image by ejecting ink onto a printing medium or an electrophotography type image forming apparatus which forms an image by transferring and fixing a toner image on a printing medium.

A display unit 109 is a display which displays, for example, layout data created by the information processing apparatus 100, and is connected to the CPU 103.

An input unit 110 allows the user to input a print execution instruction to the information processing apparatus 100 and to control that apparatus to create layout data, and is connected to the CPU 103.

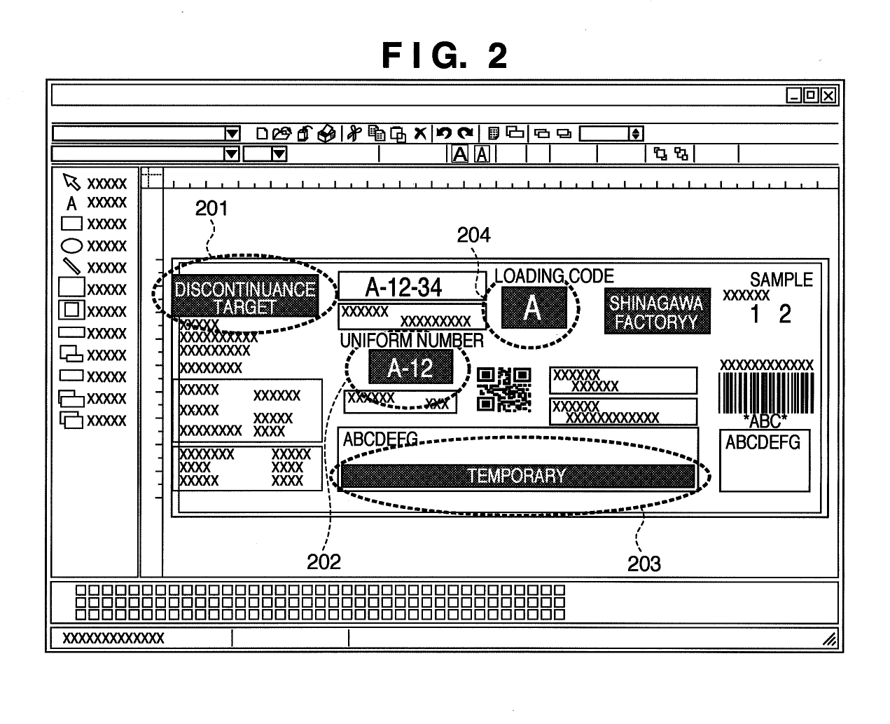

FIG. 2 shows a screen example in case the program of the layout data creation unit 104 is launched on the information processing apparatus 100, and the display unit 109 included in the information processing apparatus 100 displays layout data (entire image) created by the program of the layout data creation unit 104.

As shown in FIG. 2, for example, in color labels used for industrial use, rectangles 201 to 204 as objects (partial images) are normally colored and filled so as to allow the human to recognize them at a glance. The layout data (entire image) includes a plurality of objects (partial images).

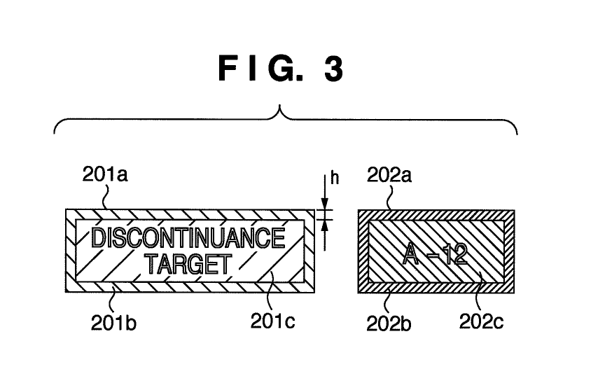

FIG. 3 shows the rectangles 201 and 202 shown in FIG. 2 after the densities of the internal parts of the rectangles are converted to reduce amounts of using printing materials such as inks or toners, and the converted rectangles are printed by the image forming unit 108 on a printing medium. A rectangle 201a after the density conversion is obtained by applying density conversion to the internal part of the rectangle 201 in FIG. 2 while the density of a contour part of the rectangle 201 is left unchanged.

Likewise, a rectangle 202a after the density conversion is obtained by applying density conversion to the internal part of the rectangle 202 in FIG. 2 while the density of a contour part of the rectangle 202 is left unchanged.

Note that contour parts 201b and 202b of the rectangles 201a and 202a after the density conversion are printed using colors designated by the user without any density conversion, and internal parts 201c and 202c are printed using colors after the density conversion. Reference symbol h denotes a contour part width, that is, the distance from the outer shape of the contour part 201b (which is the same as that of the rectangle 201) to that of the internal part 201c. This distance h is the same as a printing material reduction-inhibited width to be described later.

FIG. 4 is a diagram showing data processing in case objects (text data, rectangle data, line data, bitmap data, etc.) as partial images that form layout data (entire image), which is generated by the program of the layout data creation unit 104, are converted into rendering data, and the rendering data are sent to the image forming apparatus 102.

In this embodiment, each object includes data associated with a shape, coordinate information (position information) on the rendering area A, and luminance (RGB) data.

Also, each object has an attribute which allows the CPU 103 to recognize its type (“text”, “rectangle”, or “bitmap”). These pieces of information of the object are assigned by the program of the layout data creation unit 104.

Since each object has an attribute, as described above, the CPU 103 as the processing unit can create rendering data according to the attribute of that object upon creating rendering data on the rendering area A of the RAM 106.

As shown in FIG. 4, the CPU 103 converts each object into rendering data on the rendering area A of the RAM 106 using the program of the printer driver 105. Note that FIG. 4 shows a state in which a rectangle is converted into rendering data on the rendering area A of the RAM 106. Illustrations of conversion states of other objects will be omitted. In this embodiment, the coordinates of the rectangle include upper left and lower right coordinates.

The CPU 103 converts luminance (R, G, and B) data of the created rendering data into Black, Yellow, Magenta, and Cyan data. In case of this conversion, in case a printing material reducing mode (to be described later) is selected, and the rendering data is converted to have luminance data according to a reduction ratio, that rendering data undergoes density reduction conversion or thinning processing. The CPU 103 outputs the converted rendering data to the image forming apparatus 102 via the communication interface 101.

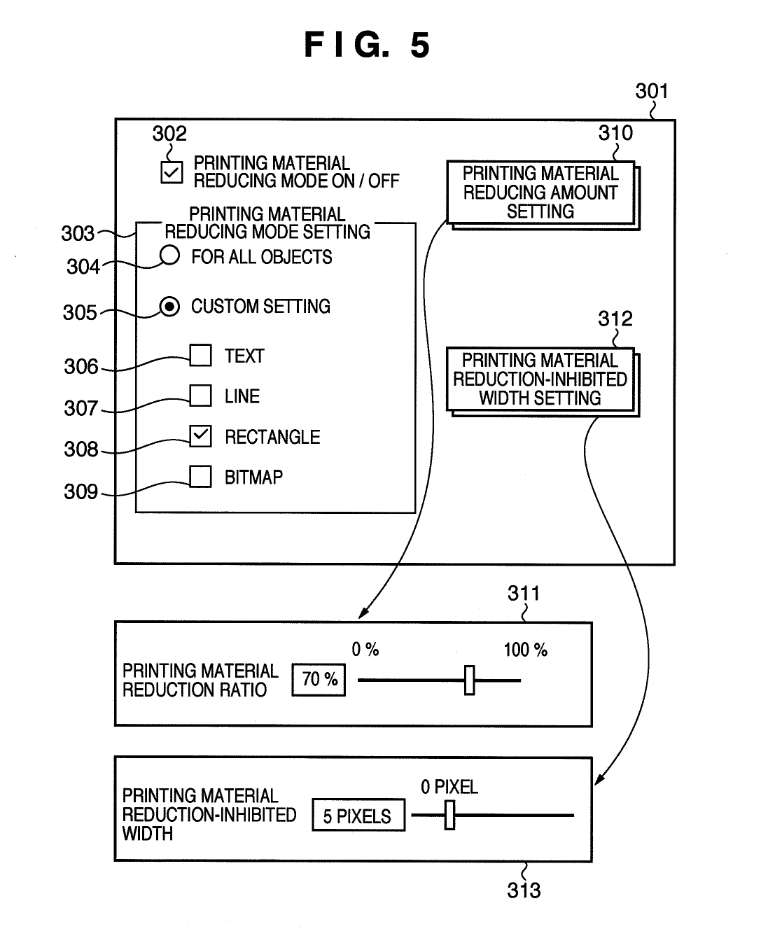

FIG. 5 shows a screen example upon displaying a screen that prompts the user to select whether or not the image forming apparatus 102 executes the printing material reducing mode for reducing the amounts of using printing materials such as inks or toners on the display unit 109 included in the information processing apparatus 100.

In this embodiment, a mode selection program used to select the printing material reducing mode is included in the program of the printer driver 105. This screen is displayed on the display unit 109 in case the user wants to print layout data created by the program of the layout data creation unit 104.

Referring to FIG. 5, in a selection window 301 used to select the printing material reducing mode, reference numeral 302 denotes a check column used to decide whether or not to reduce amounts of using printing materials. Note that FIG. 5 shows a state in which the check column 302 is checked. At this time, the image forming apparatus 102 executes the printing material reducing mode. In an initial state (default) of the selection window 301 displayed on the display unit 109, the check column 302 is not checked. Furthermore, in the default, all check columns of a setting area 303 used to set items of the printing material reducing mode (to be described later) are disabled to be checked by the user. In case the user checks the check column 302 from the default state, a check column 304 (to be described later) is automatically checked, but other check columns are maintained in a state in which the user is not allowed to check them.

In the setting area 303, reference numeral 304 denotes a check column used to decide whether or not to execute the printing material reducing mode for all objects. The user can reduce printing materials for all objects by checking this check column 304. Note that FIG. 5 shows a state in which the check column 304 is not checked.

In the setting area 303, reference numeral 305 denotes a check column (image designation unit) used to decide objects which are to undergo printing material reduction processing. Reference numerals 306 to 309 denote check columns used to decide whether or not to execute the printing material reducing mode for text, line, rectangle, and bitmap objects, respectively. After the user selects the check column 305, he or she is allowed to select one or more of the check columns 306 to 309. Then, the user is allowed to select objects which are to undergo the printing material reduction processing. Note that FIG. 5 shows a state in which the check columns 305 and 308 are checked. At this time, the image forming apparatus 102 executes the printing material reducing mode for a rectangle object.

On the selection window 301, reference numeral 310 denotes a selection column used to set a printing material reduction ratio. Reference numeral 311 denotes a setting diagram which is displayed in case the user selects the selection column 310, and allows the user to actually set the printing material reduction ratio. The user can set the printing material reduction ratio on the setting diagram 311. FIG. 5 shows a state in which the user sets the printing material reduction ratio to be 70%. As this reduction ratio is higher, an image density becomes lower upon printing an image by the image forming apparatus 102 in case the CPU 103 executes the density conversion, or a thinned-out image is printed upon printing the image by the image forming apparatus 102 in case the CPU 103 executes the thinning processing. In this embodiment, the user can set a reduction ratio ranging from 0% to 100% in a setting diagram 311. Note that in case the user sets 100% using the setting diagram 311, no printing material is used for an internal part of an object in case that object is printed by the image forming apparatus 102. Assume that the density conversion or thinning processing of the present invention also includes a case in which the reduction ratio=100% is set, and no printing material is used for an internal part of an object.

In the selection window 301, reference numeral 312 denotes a selection column (contour width designation unit) used to set a printing material reduction-inhibited width, that is, a contour part width. The printing material reduction-inhibited width is the same as h shown in FIG. 3, that is, the distance from the outer shape of the contour part 201b to that of the internal part 201c. Reference numeral 313 denotes a setting diagram which is displayed in case the user selects the selection column 312, and allows the user to actually set a printing material reduction-inhibited width. The user can set the printing material reduction-inhibited width using the setting diagram 313. The user can set a numerical value larger than 0 as the printing material reduction-inhibited width. FIG. 5 shows a state in which the user sets “5 pixels” as the printing material reduction-inhibited width.

In this embodiment, the printing material reduction ratio and printing material reduction-inhibited width are commonly set for all text, line, rectangle, and bitmap objects. However, the printing material reduction ratio and printing material reduction-inhibited width may be allowed to be individually set for respective objects.

In case the user inputs a print execution instruction to the information processing apparatus 100 on the selection window 301 while he or she sets the printing material reduction ratio and printing material reduction-inhibited width, the amounts of using printing materials at the time of printing can be reduced.

As described above, according to this embodiment, since objects which are to undergo the printing material reduction processing can be selected, an object for which the user does not want to lower the density of an internal part can be prevented from undergoing the printing material reduction processing.

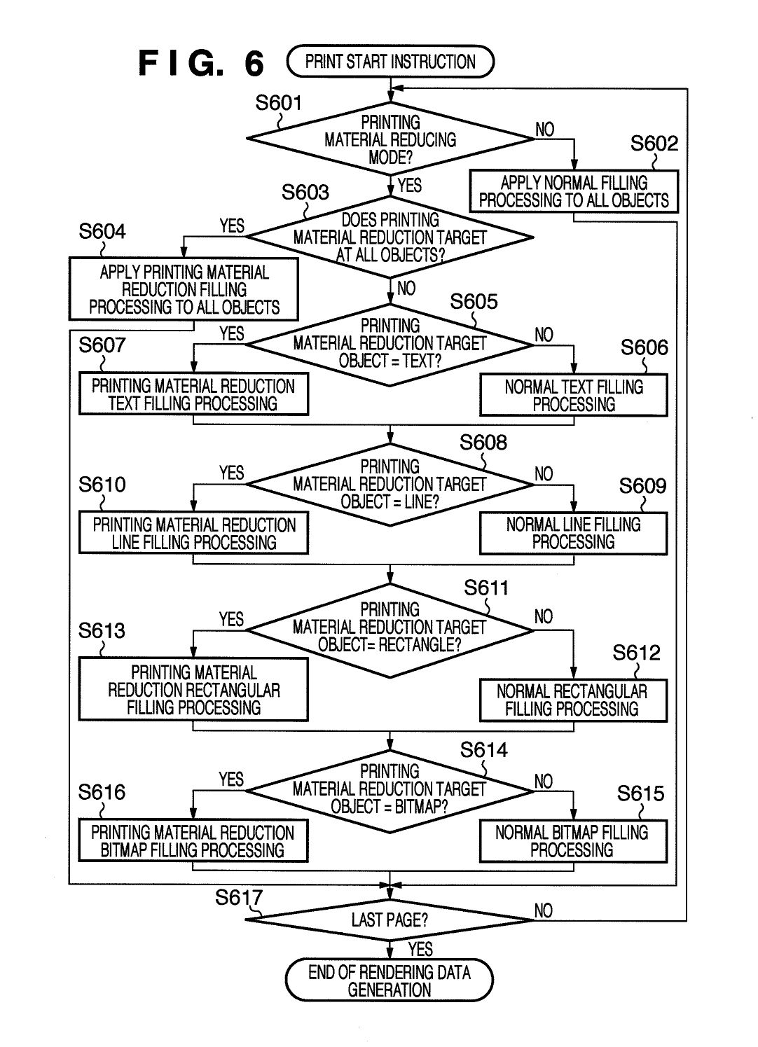

FIG. 6 is a flowchart of processing for creating rendering data in the information processing apparatus 100 in case the user inputs a print execution instruction to the information processing apparatus 100. This processing will be described below using FIG. 6.

In case the user inputs a print execution instruction to the information processing apparatus 100, the CPU 103 checks whether or not the user selects to execute the printing material reducing mode on the selection window 301 (S601). If the user does not select to execute the printing material reducing mode on the selection window 301 (NO in S601), the CPU 103 applies normal filling processing to all objects (S602), and then checks if the current page is the last page (S617). If YES in step S617, the CPU 103 ends the rendering data generation. If NO in step S617, the process returns to step S601, and the CPU 103 repeats the processing until rendering data of the last page is created.

If the user selects to execute the printing material reducing mode on the selection window 301 (YES in S601), the CPU 103 checks if the printing material reducing mode targets at all objects. If YES in step S603, the CPU 103 executes printing material reduction filling processing for all the objects (S604), and then checks if the current page is the last page (S617). If YES in step S617, the CPU 103 ends the rendering data creation processing. If NO in step S617, the process returns to step S601, and the CPU 103 repeats the processing until rendering data of the last page is created.

If NO in step S603, the CPU 103 checks whether or not a printing material reduction target object is a text object (S605). If NO in step S605, the CPU 103 executes normal text filling processing (S606); otherwise, it executes printing material reduction text filling processing (S607). After that, the process advances to step S608.

The CPU 103 checks in step S608 whether or not a printing material reduction target object is a line object. If NO in step S608, the CPU 103 executes normal line filling processing (S609); otherwise, it executes printing material reduction line filling processing (S610). After that, the process advances to step S611.

The CPU 103 checks in step S611 whether or not a printing material reduction target object is a rectangle object. If NO in step S611, the CPU 103 executes normal rectangular filling processing (S612); otherwise, it executes printing material reduction rectangular filling processing (S613). After that, the process advances to step S614.

The CPU 103 checks in step S614 whether or not a printing material reduction target object is a bitmap object. If NO in step S614, the CPU 103 executes normal bitmap filling processing (S615); otherwise, it executes printing material reduction bitmap filling processing (S616). After that, the process advances to step S617. If YES in step S617, the CPU 103 ends the rendering data creation processing. If NO in step S617, the process returns to step S601, and the CPU 103 repeats the processing until rendering data of the last page is created.

Then, the CPU 103 converts luminance (R, G, and B) data of the created rendering data into Black, Yellow, Magenta, and Cyan data, and outputs the converted rendering data to the image forming apparatus 102 via the communication interface 101. Note that the rendering data whose luminance data have been changed to those according to the reduction ratio (to be described later) upon selection of the printing material reducing mode undergoes density reducing conversion in case the luminance data are converted into Black, Yellow, Magenta, and Cyan data.

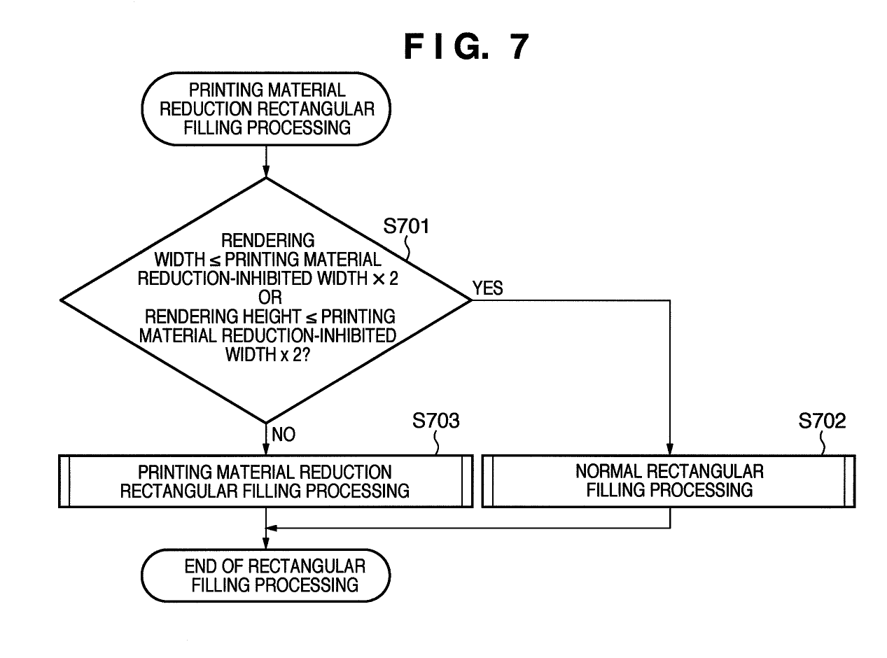

FIG. 7 is a flowchart executed in case the CPU 103 executes the printing material reduction rectangular filling processing (S613 in FIG. 6) using the program of the printer driver 105.

The CPU 103 compares the rendering width and height of a rectangle with the printing material reduction-inhibited width×2 based on the setting of the printing material reduction-inhibited width set by the user on the selection window 301 (S701). In this case, the rendering width of the rectangle indicates a dimension in the X direction on the rendering area shown in FIG. 4, and the rendering height of the rectangle indicates a dimension in the Y direction on the rendering area shown in FIG. 4. If the comparison result in step S701 is YES, that is, if the rendering width and height of the rectangle are equal to or smaller than the printing material reduction-inhibited width×2, the CPU 103 determines that the rectangle does not have a printing material reducing width, and executes normal rectangular filling processing (S702). Then, the CPU 103 ends the rectangular filling processing. The normal rectangular filling processing method will be described later.

If the comparison result in step S701 is NO, that is, if the rendering width and height of the rectangle are larger than the printing material reduction-inhibited width×2, the CPU 103 determines that the rectangle has a printing material reducing width, and executes printing material reduction rectangular filling processing (S703). Then, the CPU 103 ends the rectangular filling processing.

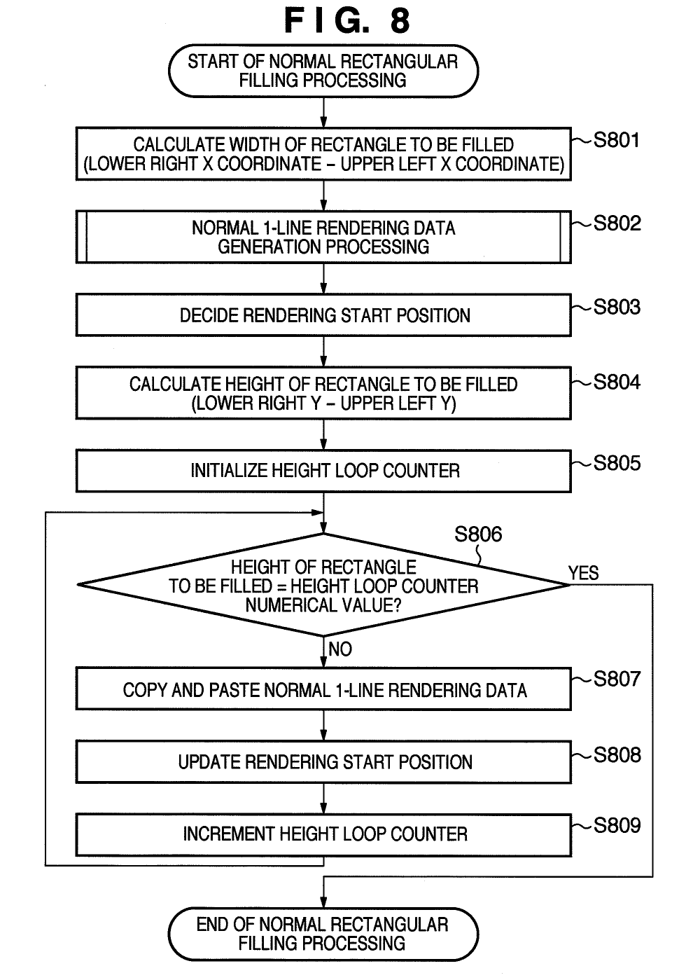

FIG. 8 is a flowchart showing the sequence executed in case the CPU 103 executes the normal rectangular filling processing (S612 in FIG. 6, S702 in FIG. 7) using the program of the printer driver 105. The CPU 103 calculates a width of a rectangle to be filled based on the layout data created by the program of the layout data creation unit 104 (S801). The width of the rectangle assumes a value obtained by subtracting the upper left X coordinate from the lower right X coordinate as the position information of the rectangle.

After the width of the rectangle is calculated, the CPU 103 executes normal 1-line rendering data generation processing (S802). The normal 1-line rendering data generation processing method will be described later. In this embodiment, “1-line rendering data” is rendering data obtained by arranging 1-pixel image data in the X direction. The normal 1-line rendering data generation processing method will be described later. Also, “normal 1-line rendering data” indicates width (X direction) data of the rectangle in case the density conversion to be described later is skipped.

After the CPU 103 executes the normal 1-line rendering data generation processing, it decides a rendering start position on the rendering area A based on the layout data created by the program of the layout data creation unit 104 (S803).

The CPU 103 calculates a height of the rectangle to be filled based on the layout data created by the program of the layout data creation unit 104 (S804). The height of the rectangle assumes a value obtained by subtracting the upper left Y coordinate from the lower right Y coordinate as the position information of the rectangle.

Then, the CPU 103 initializes a Loop counter in the height direction of the rectangle (S805). In this embodiment, initializing this height Loop counter is to set a numerical value of the height Loop counter to be “0”. Also, in this embodiment, the height Loop counter of the rectangle indicates a numerical value of the number of 1-line rendering data arranged in the Y direction.

The CPU 103 compares the height of the rectangle to be filled with the height Loop counter numerical value (S806). If the height of the rectangle to be filled does not assume the same value as the height Loop counter numerical value, that is, if NO in step S806, the CPU 103 copies the normal 1-line rendering data generated in step S802, and pastes it at the rendering start position decided in step S803 (S807). As a result, rectangular filling processing for one line is complete.

After completion of pasting of the normal 1-line rendering data, the CPU 103 updates the rendering start position to a position one pixel below the pasted rendering data (S808).

After that, the CPU 103 increments the height Loop counter (S809), and the process returns to step S806 to compare the height of the rectangle to be filled and the height Loop counter numerical value.

The CPU 103 repeats the processes in steps S806 to S809. If the height of the rectangle to be filled matches the height Loop counter numerical value in step S806 (YES in S806), the CPU 103 ends the normal rectangular filling processing.

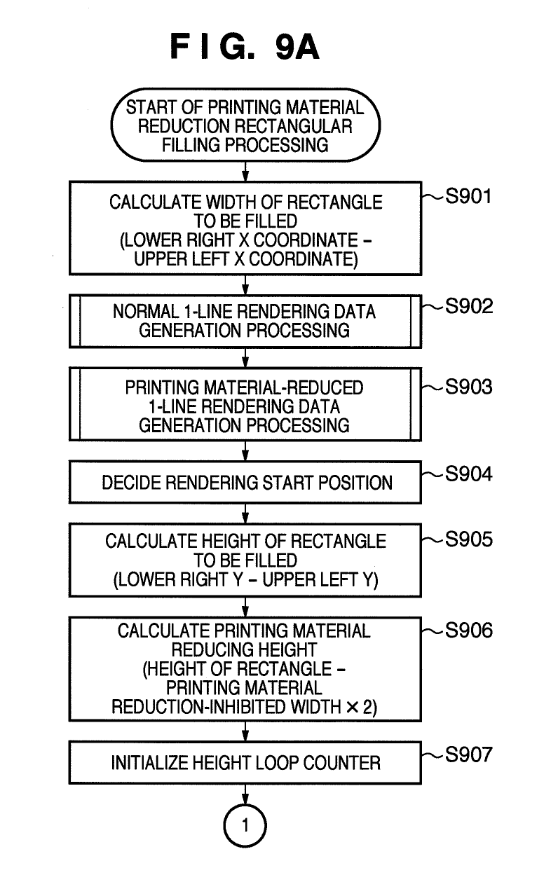

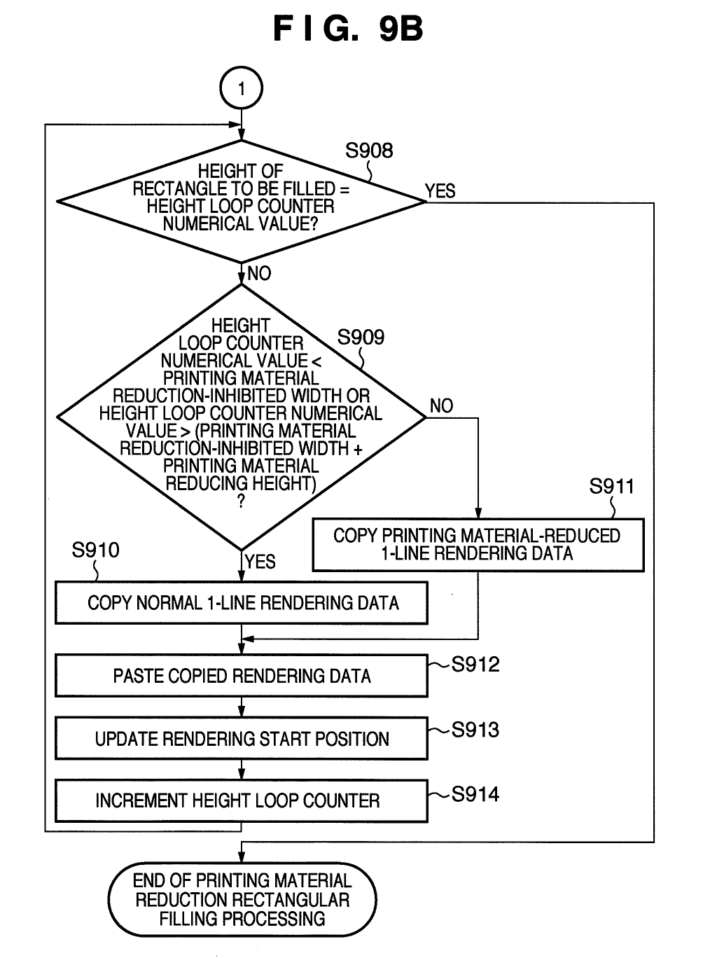

FIGS. 9A and 9B are flowcharts showing the sequence executed in case the CPU 103 executes the printing material reduction rectangular filling processing in FIG. 7 using the program of the printer driver 105.

The CPU 103 calculates a width of the rectangle to be filled based on the layout data created by the program of the layout data creation unit 104 (S901). The width of the rectangle assumes a value obtained by subtracting the upper left X coordinate from the lower right X coordinate as the position information of the rectangle.

After the CPU 103 calculates the width of the rectangle, it executes the normal 1-line rendering data generation processing (S902). The normal 1-line rendering data generation processing method will be described later.

Furthermore, the CPU 103 executes printing material-reduced 1-line rendering data generation processing (S903). The printing material-reduced 1-line rendering data generation processing method will be described later.

After the normal 1-line rendering data generation processing and printing material-reduced 1-line rendering data generation processing, the CPU 103 decides a rendering start position based on the layout data created by the program of the layout data creation unit 104 (S904).

The CPU 103 calculates a height of the rectangle to be filled based on the layout data created by the program of the layout data creation unit 104 (S905). The height of the rectangle assumes a value obtained by subtracting the upper left Y coordinate from the lower right Y coordinate as the position information of the rectangle.

Furthermore, the CPU 103 calculates a printing material reducing height based on the layout data created by the program of the layout data creation unit 104 (S906). This printing material reducing height assumes a value obtained by subtracting a numerical value of the printing material reduction-inhibited width×2 from the height of the rectangle calculated in step S905.

The CPU 103 initializes a Loop counter in the height direction of the rectangle (S907). In this embodiment, initializing this height Loop counter is to set a numerical value of the height Loop counter to be “0”. Also, in this embodiment, the height Loop counter of the rectangle indicates a numerical value of the number of 1-line rendering data arranged in the Y direction.

The CPU 103 compares the height of the rectangle to be filled with the height Loop counter numerical value (S908). If the height of the rectangle to be filled does not assume the same value as the height Loop counter numerical value, that is, if NO in step S906, the process advances to step S909.

In step S909, the CPU 103 compares the height Loop counter numerical value with the printing material reduction-inhibited width and also the height Loop counter numerical value with (printing material reduction-inhibited width +printing material reducing height). If one of inequalities (height Loop counter numerical value<printing material reduction-inhibited width) and (height Loop counter numerical value>(printing material reduction-inhibited width+printing material reducing height)) is satisfied, the CPU 103 determines YES (YES in S909). If neither of the two inequalities are satisfied, the CPU 103 determines NO (NO in S909).

If YES in step S909, the CPU 103 copies the normal 1-line rendering data generated in step S902 (S910); otherwise, it copies printing material-reduced 1-line rendering data generated in step S903 (S911).

The CPU 103 pastes the data copied in step S910 or S911 to the rendering start position decided in step S904 (S912).

After completion of pasting of the rendering data for one line, the CPU 103 updates the rendering start position to a position one pixel below the pasted rendering data (S913).

After that, the CPU 103 increments the height Loop counter (S914), and the process returns to step S908 to execute the above checking process.

The CPU 103 repeats the processes in steps S908 to S914. If the height of the rectangle to be filled matches the height Loop counter numerical value in step S908 (YES in S908), the CPU 103 ends the printing material reduction rectangular filling processing.

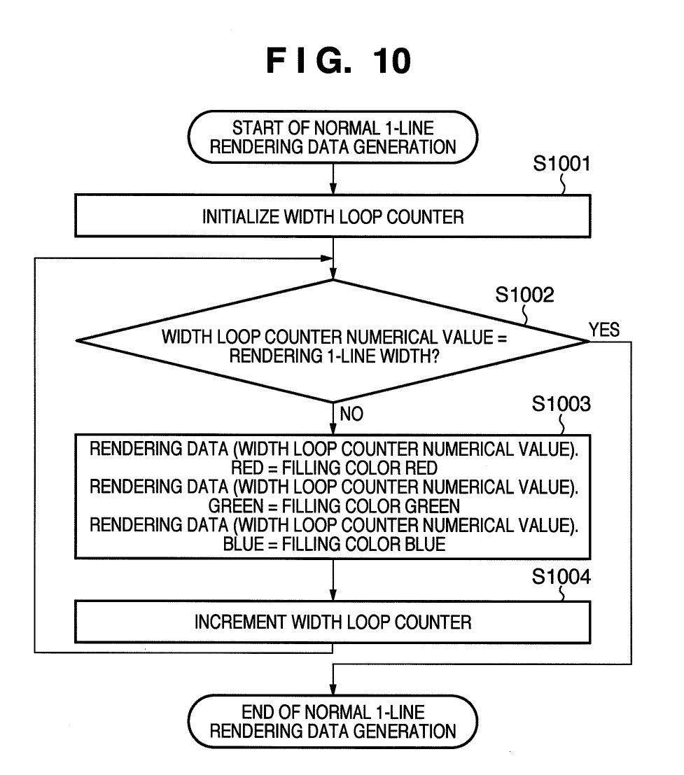

FIG. 10 is a flowchart showing the sequence executed in case the CPU 103 executes the normal 1-line rendering data generation processing in FIGS. 8 and 9 using the program of the printer driver 105.

The CPU 103 initializes a Loop counter in the width direction of the rectangle (S1001). In this embodiment, initializing this width Loop counter is to set a numerical value of the width Loop counter to be “0”. Also, in this embodiment, the width Loop counter of the rectangle indicates a numerical value of the number of 1-pixel rendering data arranged in the X direction.

The CPU 103 compares the width Loop counter numerical value with a rendering 1-line width (the width calculated in step S801 in FIG. 8 or that calculated in step S901 in FIG. 9A) (S1002). If the two values are not equal to each other, that is, if NO in step S1002, the process advances to step S1003.

In step S1003, the CPU 103 decides colors at a position corresponding to the width Loop counter numerical value in the rectangle. The CPU 103 applies rendering data (Red, Green, and Blue) associated with the colors to the corresponding position based on the layout data created by the program of the layout data creation unit 104. These rendering data indicate colors which are to be rendered and filled at the corresponding position.

After the CPU 103 decides the colors at the position corresponding to the width Loop counter numerical value in the rectangle and applies them to the corresponding position in step S1003, it increments the width Loop counter (S1004). The process then returns to step S1002 to compare the width Loop counter numerical value with the rendering 1-line width.

The CPU 103 repeats the processes in steps S1002 to S1004. If the width Loop counter numerical value matches the rendering 1-line width in step S1002 (YES in S1002), the CPU 103 ends the normal 1-line rendering data generation processing.

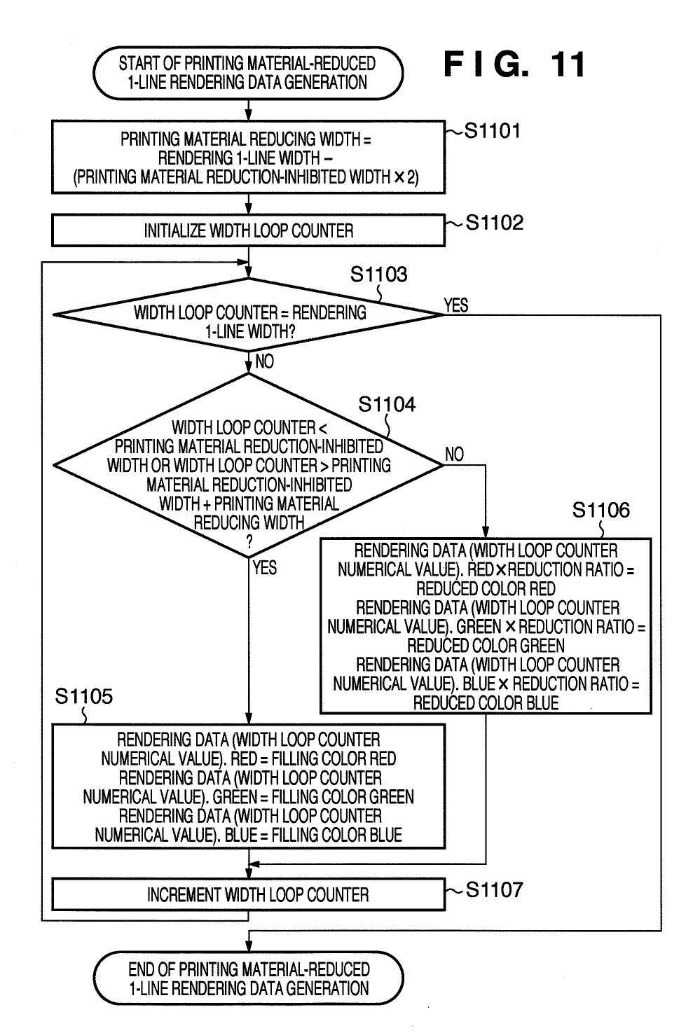

FIG. 11 is a flowchart showing the sequence executed in case the CPU 103 executes the printing material-reduced 1-line rendering data generation processing in FIG. 9A using the program of the printer driver 105.

The CPU 103 calculates a printing material reducing width in one line (S1101). This printing material reducing width assumes a value obtained by subtracting a numerical value of the printing material reduction-inhibited width×2 from the rendering 1-line width (the width calculated in step S901 in FIG. 9A).

After the CPU 103 calculates the printing material reducing width in one line, it initializes a Loop counter in the width direction in the rectangle (S1102). In this embodiment, initializing this width Loop counter is to set a numerical value of the width Loop counter to be “0”. Also, in this embodiment, the width Loop counter of the rectangle indicates a numerical value of the number of 1-pixel rendering data arranged in the X direction.

The CPU 103 compares the width Loop counter numerical value with the rendering 1-line width (the width calculated in step S901 in FIG. 9A) (S1103). If the two values are not equal to each other, that is, if NO in step S1103, the process advances to step S1104.

In step S1104, the CPU 103 compares the width Loop counter numerical value with the printing material reduction-inhibited width and also the width Loop counter numerical value with (printing material reduction-inhibited width+printing material reducing width). If one of inequalities (width Loop counter numerical value<printing material reduction-inhibited width) and (width Loop counter numerical value>(printing material reduction-inhibited width+printing material reducing width)) is satisfied, the CPU 103 determines YES (YES in S1104). If neither of the two inequalities are satisfied, the CPU 103 determines NO (NO in S1104).

If YES in step S1104, the process advances to step S1105, and the CPU 103 decides colors at a position corresponding to the width Loop counter numerical value in the rectangle. The CPU 103 applies rendering data (Red, Green, and Blue) associated with the colors to the corresponding position based on the layout data created by the program of the layout data creation unit 104 (S1105). These rendering data indicate colors which are to be rendered and filled at the corresponding position.

If NO in step S1104, the process advances to step S1106, and the CPU 103 decides reduced colors based on the data created by the program of the layout data creation unit 104 and the reduction ratio set on the selection window 301. For example, in case of Red, if a maximum output level is “255”, the reduced color can be calculated by a formula (255−(Red output before reduction))×(reduction ratio/100). Note that the unit of the reduction ratio is % (percent). For Green and Blue as well, reduced colors can be calculated using the same formula. The CPU 103 decides the output levels calculated by the above formula as reduced colors at the position corresponding to the width Loop counter numerical value in the rectangle. Then, the CPU 103 applies the decided reduced colors to the corresponding position (S1106).

After the CPU 103 decides the colors or reduced colors at the position corresponding to the width Loop counter numerical value in the rectangle in step S1105 or S1106, and applies them to that position, it increments the width Loop counter (S1107). The process then returns to step S1103 to compare the width Loop counter numerical value with the rendering 1-line width.

The CPU 103 repeats the processes in steps S1103 to S1107. If the width Loop counter numerical value matches the rendering 1-line width in step S1103 (YES in S1103), the CPU 103 ends the printing material-reduced 1-line rendering data generation processing.

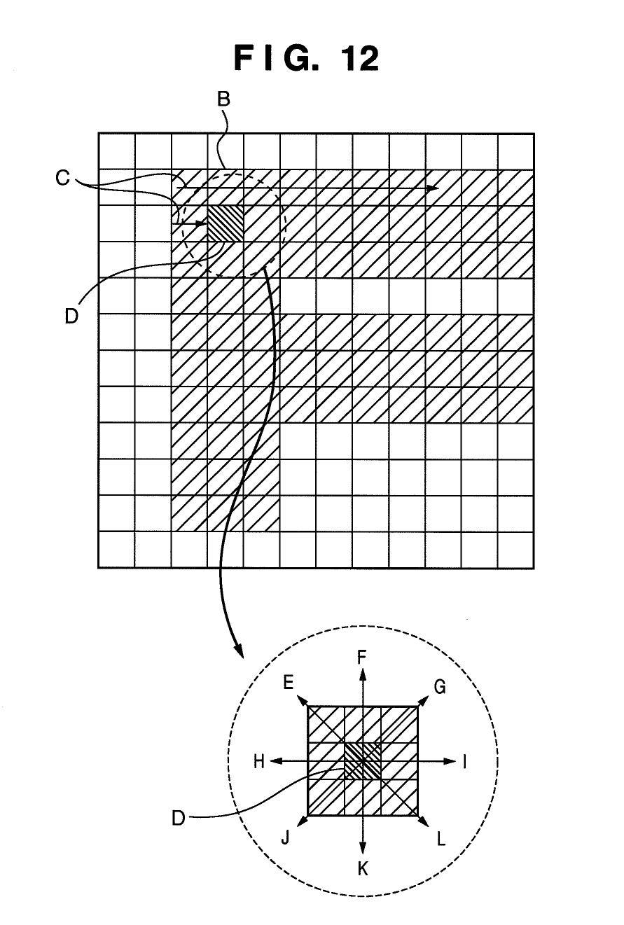

FIG. 12 is a view showing a state in which text is rendered on the rendering area A. Upon rendering text on the rendering area A, the CPU 103 starts rendering from a pixel B at the upper leftmost and uppermost position. Then, the CPU 103 sequentially fills pixels in the X direction from the pixel B as indicated by an arrow C. In case the CPU 103 fills the rightmost pixel in the X direction of the pixel B in that text, it fills the leftmost pixel in a line below the pixel B. FIG. 12 shows the example in which text is rendered. Also, line and bitmap objects are filled by the same method.

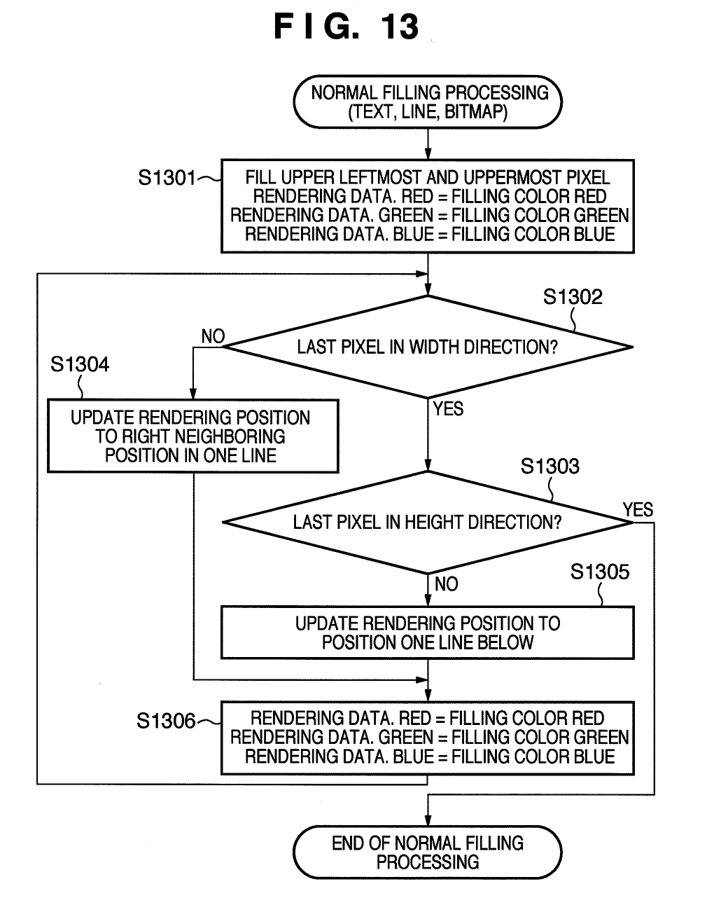

FIG. 13 is a flowchart showing the sequence in case the CPU 103 executes the normal filling processing (steps S606, S609, and S615) in FIG. 6. This sequence is a flowchart common to text, line, and bitmap objects.

The CPU 103 applies rendering data (Red, Green, and Blue) associated with colors based on the layout data created by the program of the layout data creation unit 104 to a position corresponding to a pixel at the upper leftmost and uppermost position of an object whose rendering data is to be created, thereby filling that pixel (S1301). These rendering data indicate colors which are to be rendered and filled at that position.

The CPU 103 checks whether or not the pixel filled in step S1301 is the last pixel (right end) in the width direction of a line including that pixel (S1302). If YES in step S1302, the CPU 103 checks whether or not the filled pixel is the last pixel (lower end) in the height direction (S1303). If YES in step S1303, the CPU 103 ends the normal filling processing of that object.

If NO in step S1302, the CPU 103 updates the rendering position to the right neighboring position (S1304), and the process advances to step S1306.

If NO in step S1303, the CPU 103 judges that filling in that line is complete, and updates the rendering position to the left end of the object one line below (S1305). The process then advances to step S1306.

The CPU 103 decides colors at the updated rendering position in step S1304 or S1305. The CPU 103 applies rendering data (Red, Green, and Blue) associated with the colors to that updated position based on the layout data created by the program of the layout data creation unit 104, thereby filling the corresponding pixel (S1306). These rendering data indicate colors which are to be rendered and filled at that position.

The process then returns to step S1302, and the CPU 103 repeats the subsequent sequence until the normal filling processing is completed.

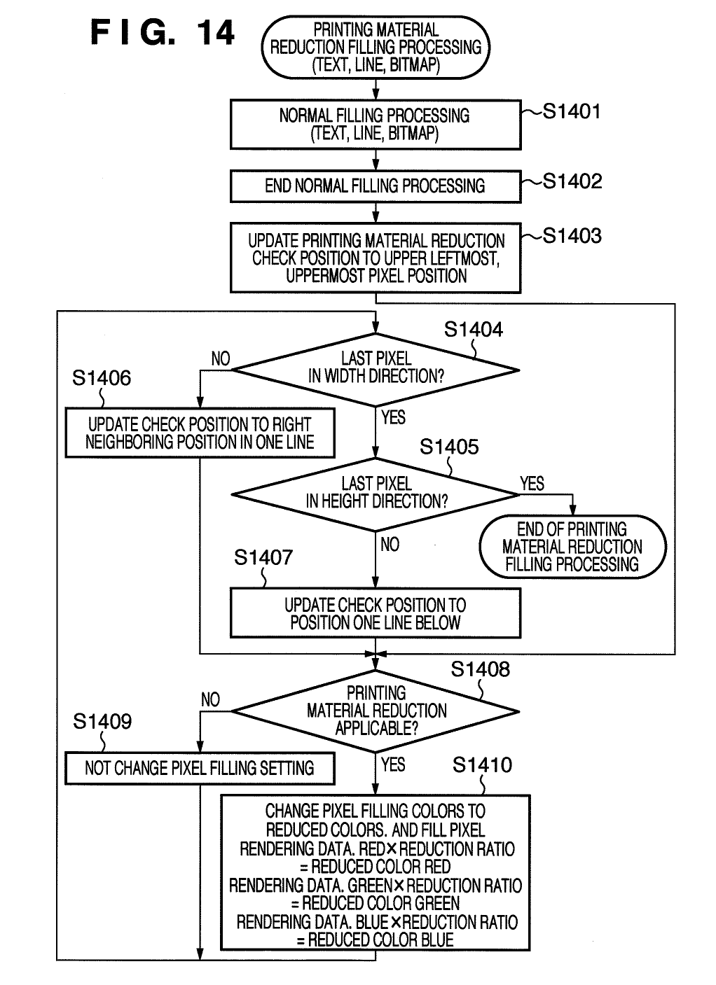

FIG. 14 is a flowchart showing the sequence executed in case the CPU 103 executes the printing material reduction filling processing (steps S607, S610, and S616) in FIG. 6. This sequence is a flowchart common to text, line, and bitmap objects.

The CPU 103 executes the normal filling processing of the object described using the flowchart shown in FIG. 13 (S1401), and completes the normal filling processing (S1402).

After that, the CPU 103 updates a position of a pixel, which is to be checked as to whether or not the printing material reduction is applicable, as will be described later, to the upper leftmost, uppermost pixel position (S1403), and the process advances to step S1408.

The check method in step S1408 will be described in detail below.

Let D in FIG. 12 be a pixel which is to be checked in step S1408 as to whether or not the printing material reduction is applicable. The CPU 103 calculates the number of continuous already filled pixels from a pixel which neighbors the pixel D in an obliquely upper left direction with respect to the pixel D (for example, one pixel in FIG. 12). Then, the CPU 103 compares the calculated number of pixels with the number of printing material reduction-inhibited pixels (the numerical value set on the selection window 301) to check if the calculated number of pixels is equal to or larger than the number of printing material reduction-inhibited pixels. The CPU 103 also executes this checking process in F, G, H, I, J, K, and L directions in FIG. 12. If the check result satisfies (the calculated number of pixels)≧(the number of printing material reduction-inhibited pixels), the CPU 103 judges that the printing material reduction is applicable to the pixel D (YES in S1408). Note that the numbers of continuous already filled pixels from pixels which neighbor the pixel D in FIG. 12 are as follows: F direction=1 pixel, G direction=1 pixel, H direction=1 pixel, I direction=6 pixels, J direction=1 pixel, K direction=8 pixels, and L direction=1 pixel.

The check method in step S1408 has been described.

If NO in step S1408, the CPU 103 does not change a filling setting for the pixel that is checked in step S1408 as to whether or not the printing material reduction is applicable (S1409). That is, the printing material reduction is skipped for that pixel.

If YES in step S1408, the CPU 103 decides reduced colors based on the data created by the program of the layout data creation unit 104 and the reduction ratio set on the selection window 301. For example, in case of Red, if a maximum output level is “255”, the reduced color can be calculated from the formula (255−(Red output before reduction))×(reduction ratio/100). Note that the unit for the reduction ratio is % (percent). For Green and Blue as well, reduced colors can be calculated using the same formula. The CPU 103 decides the output levels calculated by the above formula as reduced colors for the pixel which is checked in step S1408 as to whether or not the printing material reduction is applicable. Then, the CPU 103 changes already filled filling colors of that pixel to the reduced colors, and fills that pixel with the reduced colors (S1410).

Then, the process advances to step S1404, and the CPU 103 checks whether or not the pixel, which is checked in step S1408 as to whether or not the printing material reduction is applicable, is the last pixel (right end) in the width direction of a line including that pixel. If the checked pixel is the last pixel in the width direction, that is, if YES in step S1404, the CPU 103 checks whether or not that pixel is the last pixel (lower end) in the height direction (S1405). If the checked pixel is the last pixel in the height direction, that is, if YES in step S1405, the CPU 103 ends the printing material reduction filling processing of that object.

If NO in step S1404, the CPU 103 updates the check position to a right neighboring pixel (S1406), and the process advances to step S1408.

If NO in step S1405, the CPU 103 judges that the check operation as to whether or not the printing material reduction is applicable in that line is complete, and updates a pixel position where it is checked whether or not the printing material reduction is applicable to the left end position of the object one line below (S1407). The process then advances to step S1408.

Then, the CPU 103 checks in step S1408 whether or not the printing material reduction is applicable to a pixel to be filled, and the process returns to step S1404 via step S1409 or S1410. Then, the CPU 103 repeats the subsequent sequence until the check operation as to whether or not the printing material reduction is applicable is completed for all the pixels.

As described above, according to this embodiment, since the user can select objects which are to undergo the printing material reduction, the printing material reduction can be skipped for an object that the user does not want to reduce the density of an internal part.

In this embodiment, objects which are to undergo the printing material reduction are decided in case the user selects the object types (text, line, bitmap, etc.), and the density conversion is applied to all the objects of the selected types. However, the user may be allowed to individually select objects on the screen shown in FIG. 2 upon displaying layout data created by the program of the layout data creation unit, and the density conversion may be applied to the selected objects.

### Another Embodiment

The processing for applying the density conversion to data corresponding to an internal part of a selected object except for its contour in case the CPU 103 executes the printing material reduction processing for the selected object has been described. However, the present invention is not limited to the above embodiment. In case the CPU 103 executes the printing material reduction processing for a selected object, thinning processing may be applied to data corresponding to an internal part of the selected object except for its contour.

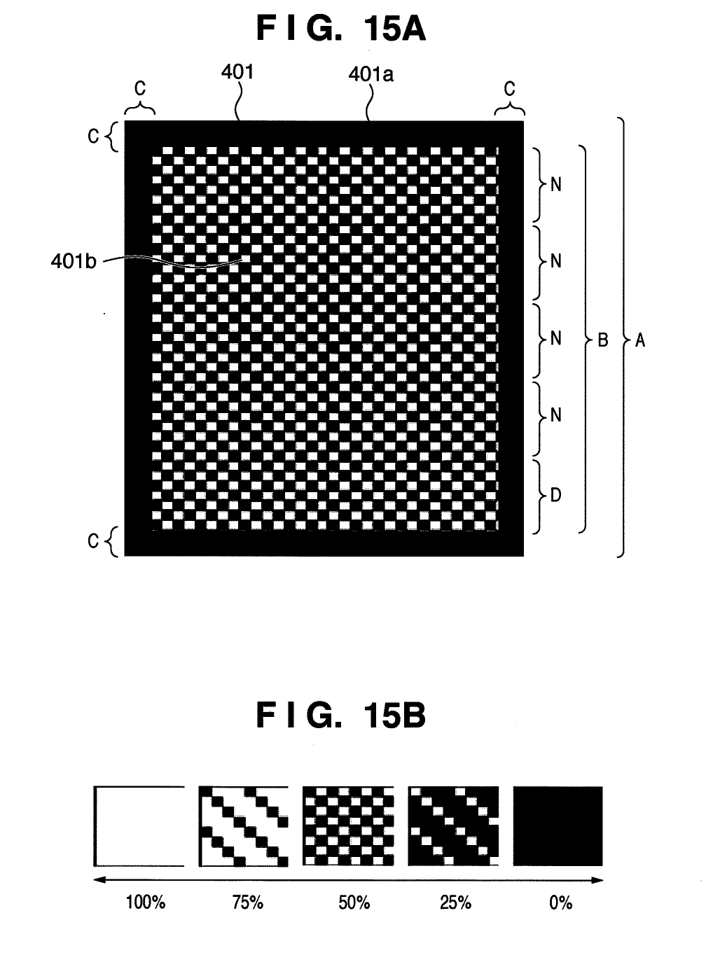

A case will be described in detail below wherein the thinning processing is executed as the printing material reduction processing. FIGS. 15A and 15B show pattern examples upon execution of the thinning processing. FIG. 15A shows a rectangle 401, the internal part of which has undergone the thinning processing so as to reduce amounts of using printing materials such as inks or toners, and which is printed on a printing medium by the image forming unit 108. The rectangle 401 after the thinning processing is obtained by applying the thinning processing to a rectangle internal part 401b while skipping that processing to a contour part 401a of the rectangle 401 in FIG. 15A. Note that the rectangle internal part 401b in FIG. 15A has undergone the thinning processing of 50%. FIG. 15B shows thinning pattern examples corresponding to reduction ratios which can be selected on the setting diagram 311 in case the user wants to execute the printing material reducing mode shown in FIG. 5. The thinning patterns shown in FIG. 15B are those which are stored as pre-settable patterns of the printer driver 105, and indicate a 100% reducing pattern, 75% reducing pattern, 50% reducing pattern, 25% reducing pattern, and 0% reducing pattern in turn from the left. In this embodiment, the user can select one thinning pattern from the 100%, 75%, 50%, 25%, and 0% patterns. However, the present invention is not limited to this, and other thinning patterns may be pre-stored in the printer driver 105 so that the user can select thinning patterns of other ratios (%).

Each thinning pattern shown in FIG. 15B is applied to the entire rendering area A shown in FIG. 4. Then, one of thinning pattern ON (black) and thinning pattern OFF (white) positions is assigned to each coordinate position of the rendering area A. As will be described later, this thinning pattern is used to allow pasting data at a position corresponding to the thinning pattern ON (black) position and not pasting data at a position corresponding to the thinning pattern OFF (white) position in case the CPU 103 pastes rendering data on the rendering area A.

The sequence in case the CPU 103 executes the thinning processing will be described below. Note that the CPU 103 also executes the processing sequences shown in FIGS. 6, 7, and 8 upon execution of the thinning processing. However, since the sequences shown in FIGS. 6, 7, and 8 have already been described above, a repetitive description will be avoided. Since the thinning processing is different from the density conversion in the printing material reduction rectangular filling processing (step S613) in FIG. 6 and the printing material reduction filling processing (steps S607, S610, and S616) in FIG. 6, these processes will be described in detail below.

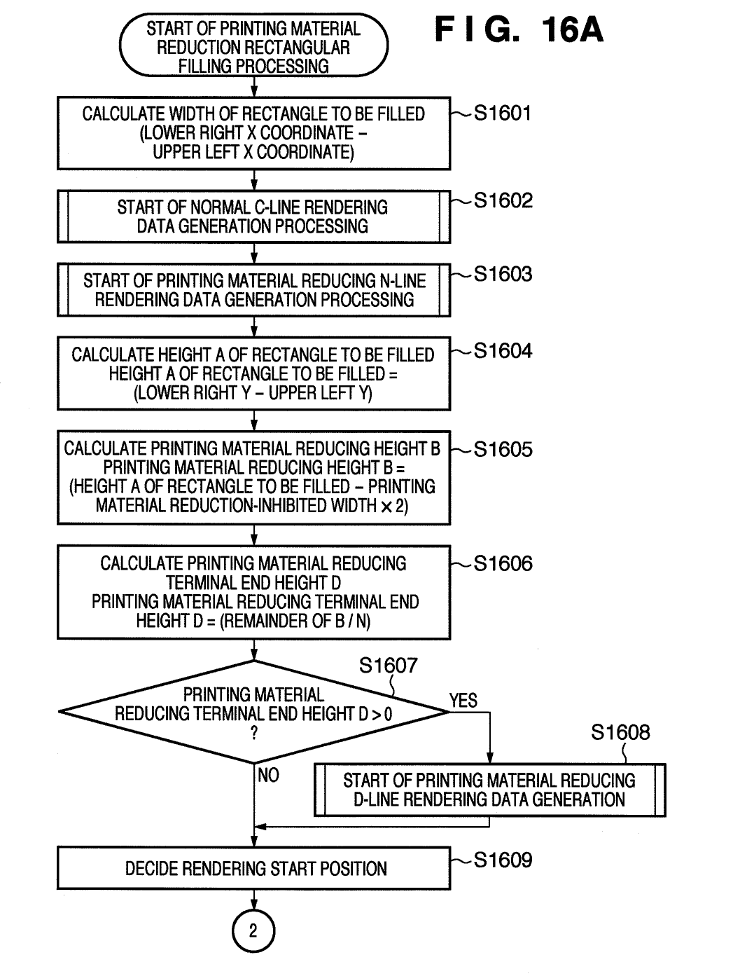

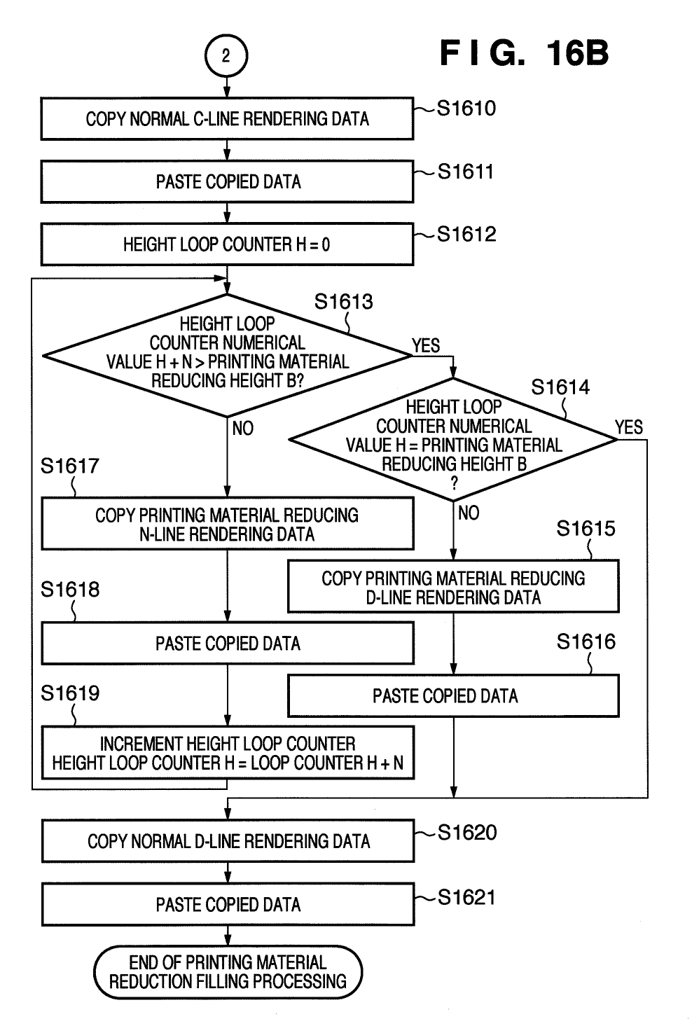

FIGS. 16A and 16B are flowcharts showing the sequence executed in case the CPU 103 executes the printing material reduction rectangular filling processing (step S613) in FIG. 6 using the program of the printer driver 105.

The CPU 103 calculates a width of a rectangle to be filled based on layout data created by the program of the layout data creation unit 104 (S1601). The width of the rectangle assumes a value obtained by subtracting the upper left X coordinate from the lower right X coordinate as position information of the rectangle.

After the width of the rectangle is calculated, the CPU 103 executes normal C-line rendering data generation processing (S1602). The normal C-line rendering data generation processing method will be described later. The normal C lines indicate a printing material reduction-inhibited width corresponding to the contour part 401a shown in FIG. 15A.

Furthermore, the CPU 103 executes printing material reducing N-line rendering data generation processing (S1603). The printing material reducing N-line rendering data generation processing method will be described later. The printing material reducing N lines indicate a printing material reducing height corresponding to a part of the rectangle internal part 401b, as shown in FIG. 15A. This N indicates the number of lines to be collectively processed by the CPU 103, as will be described later. This numerical value is set depending on, for example, the processing capability of the CPU 103.

The CPU 103 calculates a height A (FIG. 15A) of the rectangle to be filled based on the layout data created by the program of the layout data creation unit 104 (S1604). The height A of the rectangle assumes a value obtained by subtracting the upper left Y coordinate from the lower right Y coordinate as the position information of the rectangle.

Furthermore, the CPU 103 calculates a printing material reducing height B (FIG. 15A) based on the layout data created by the program of the layout data creation unit 104 (S1605). This printing material reducing height assumes a value obtained by subtracting a numerical value of the printing material reduction-inhibited width C×2 from the height A of the rectangle calculated in step S1604. The CPU 103 calculates a printing material reducing terminal end height D based on the layout data created by the program of the layout data creation unit 104 (S1606). This printing material reducing terminal end height D indicates the remainder obtained in case the printing material reducing height B is divided by N of the printing material reducing N lines, as shown in FIG. 15A.

After step S1606, the CPU 103 checks whether or not the printing material reducing terminal end height D exceeds 0 (S1607). If the printing material reducing terminal end height D exceeds 0 (YES in S1607), the CPU 103 starts generation of printing material reducing D-line rendering data (S1608). The D-line rendering data generation processing will be described later. Then, after generation of the D-line rendering data, the CPU 103 decides a rendering start position based on the layout data created by the program of the layout data creation unit 104 (S1609). If the printing material reducing terminal end height D does not exceed 0 in step S1607 (NO in S1607), the CPU 103 decides a rendering start position based on the layout data created by the program of the layout data creation unit 104 (S1609). In step S1610, the CPU 103 copies the normal C-line rendering data generated in step S1602.

The CPU 103 pastes the data copied in step S1610 to the rendering start position decided in step S1609 (S1611).

The CPU 103 initializes a Loop counter H in the height direction of the rectangle (S1612), and the process advances to the next step. Note that in this embodiment, initializing this height Loop counter H is to set a numerical value of the height Loop counter to be “0”. Also, in this embodiment, the height Loop counter of the rectangle indicates a numerical value of the number of 1-line rendering data arranged in the Y direction.

The CPU 103 checks in step S1613 whether or not (height Loop counter H+N) is larger than the printing material reducing height B. If the CPU 103 determines that (height Loop counter H+N) is larger than the printing material reducing height B (YES in S1613), it checks whether or not the height Loop counter H is equal to the printing material reducing height B (S1614). If the CPU 103 determines that the height Loop counter H is equal to the printing material reducing height B (YES in S1614), the process jumps to step S1620. If the CPU 103 determines that the height Loop counter H is not equal to the printing material reducing height B (NO in S1614), it copies the printing material reducing D-line rendering data (S1615), and pastes the copied data (S1616). Then, the process advances to step S1620.

If the CPU 103 determines that (height Loop counter H+N) is not larger than the printing material reducing height B (NO in S1613), since N lines can be rendered, it copies the printing material reducing N-line rendering data generated in step S1603 (S1617), and pastes the copied data (S1618). Then, the CPU 103 increments the height Loop counter (it adds N to H) (S1619), and the process returns to step S1613 to execute the subsequent processes.

In case step S1620 is reached, the CPU 103 copies the normal C-line rendering data generated in step S1602 (S1620). Then, the CPU 103 pastes the data copied in step S1620 (S1621), thus ending the printing material reduction rectangular filling processing.

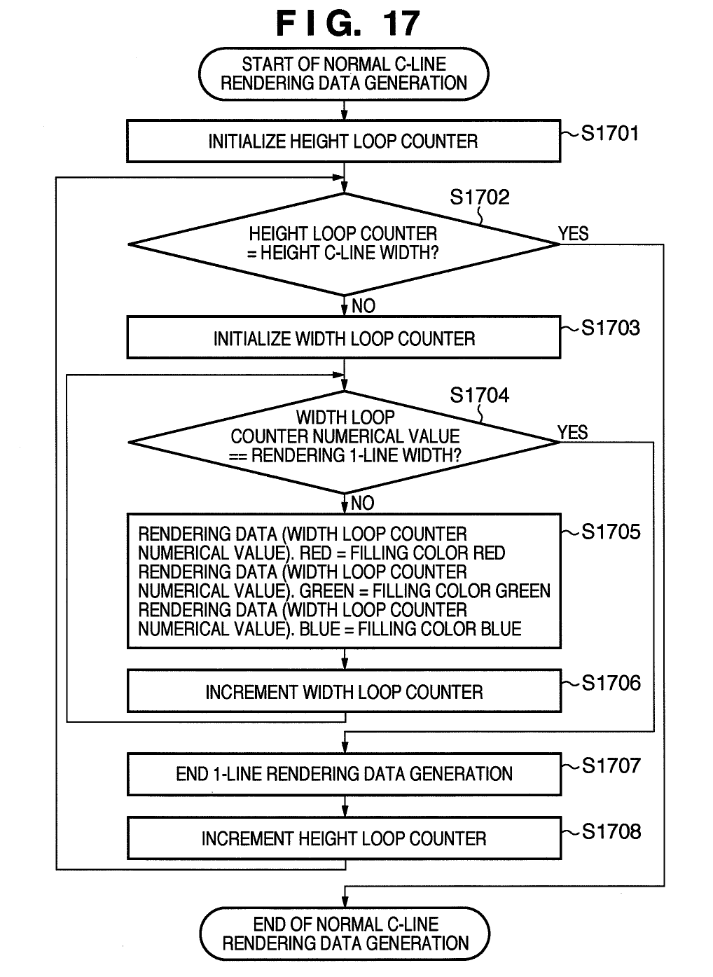

FIG. 17 is a flowchart showing the sequence in case the CPU 103 executes the normal C-line rendering data generation processing in FIG. 16A using the program of the printer driver 105.

The CPU 103 initializes a height Loop counter in the rectangle (S1701), and checks whether or not the value of the height Loop counter is equal to the height of the C lines (height C-line width) (S1702). In this embodiment, initializing this height Loop counter is to set a numerical value of the height Loop counter to be “0”. Also, in this embodiment, the height Loop counter of the rectangle indicates a numerical value of the number of 1-pixel rendering data arranged in the Y direction. If the CPU 103 determines that the value of the height Loop counter is equal to the height of the C lines (height C-line width) (YES in S1702), it ends the normal C-line rendering data generation processing. If the CPU 103 determines that the value of the height Loop counter is not equal to the height of the C lines (height C-line width) (NO in S1702), the process advances to step S1703.

The CPU 103 initializes a Loop counter in the width direction of the rectangle (S1703). In this embodiment, initializing this width Loop counter is to set a numerical value of the width Loop counter to be “0”. Also, in this embodiment, the width Loop counter of the rectangle indicates a numerical value of the number of 1-pixel rendering data arranged in the X direction.

The CPU 103 checks whether or not the value of the width Loop counter is equal to a rendering 1-line width (a length of one line in the X direction) (S1704). If the CPU 103 determines that the value of the width Loop counter is not equal to the rendering 1-line width (NO in S1704), it decides colors at a position corresponding to the width Loop counter numerical value in the rectangle in step S1705. The CPU 103 applies rendering data (Red, Green, and Blue) associated with the colors to the corresponding position based on the layout data created by the program of the layout data creation unit 104. These rendering data indicate colors which are to be rendered and filled at that position.

After the colors at the position corresponding to the width Loop counter numerical value in the rectangle are decided and are applied to that position in step S1705, the CPU 103 increments the width Loop counter (S1706). The process returns to step S1704 to check if the width Loop counter numerical value is equal to the rendering 1-line width.

If the CPU 103 determines in step S1704 that the width Loop counter value is equal to the rendering 1-line width (YES in S1704), it ends the 1-line rendering data generation processing (S1707), and increments the height Loop counter (S1708). The process returns to step S1702, and the CPU 103 repeats the subsequent sequence until it is determined that the value of the height Loop counter is equal to the height of the C lines. Then, if the CPU 103 determines that the value of the height Loop counter is equal to the height of the C lines (YES in S1702), it ends the normal C-line rendering data generation processing.

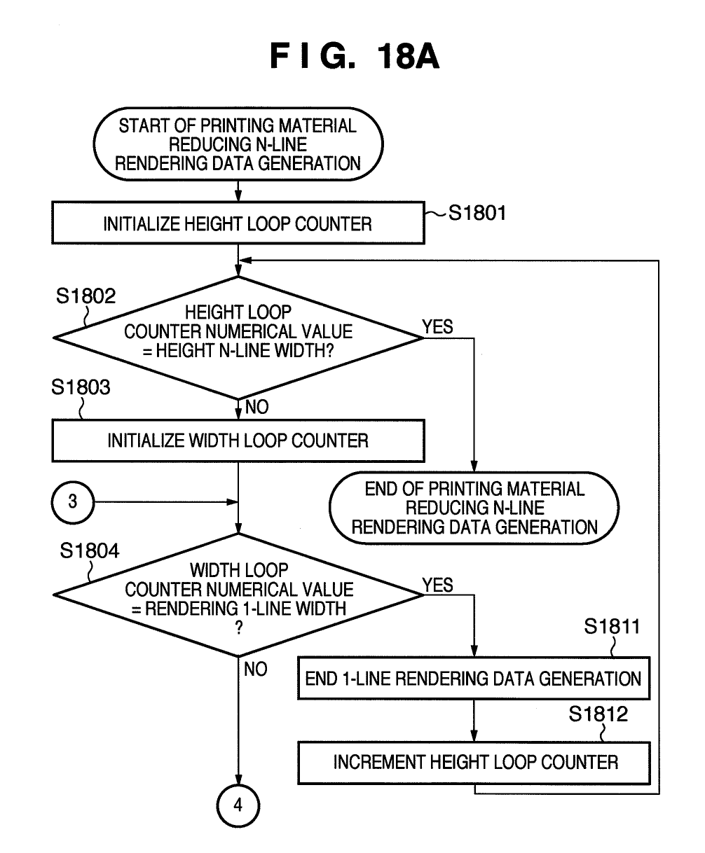

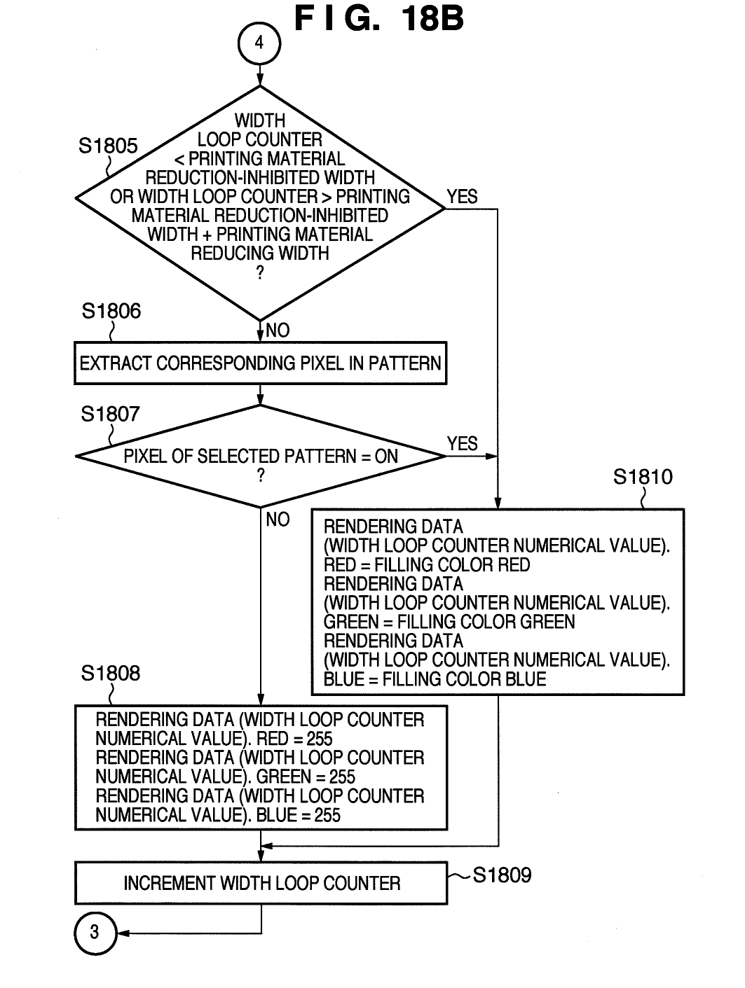

FIGS. 18A and 18B are flowcharts showing the sequence executed in case the CPU 103 executes the printing material reducing N-line rendering data generation processing in FIG. 16A using the program of the printer driver 105.

The CPU 103 initializes a height Loop counter in the rectangle (S1801), and checks whether or not the value of the height Loop counter is equal to the height of N lines (height N-line width) (S1802). In this embodiment, initializing this height Loop counter is to set a numerical value of the height Loop counter to be “0”. Also, in this embodiment, the height Loop counter of the rectangle indicates a numerical value of the number of 1-pixel rendering data arranged in the Y direction. If the CPU 103 determines that the value of the height Loop counter is equal to the heights of the N lines (height N-line width) (YES in S1802), it ends the printing material reducing N-line rendering data generation processing. If the CPU 103 determines that the value of the height Loop counter is not equal to the height of the N lines (height N-line width) (NO in S1802), the process advances to step S1803.

The CPU 103 initializes a Loop counter in the width direction of the rectangle (S1803). In this embodiment, initializing this width Loop counter is to set a numerical value of the width Loop counter to be “0”. Also, in this embodiment, the width Loop counter of the rectangle indicates a numerical value of the number of 1-pixel rendering data arranged in the X direction.

The CPU 103 checks whether or not the value of the width Loop counter is equal to a rendering 1-line width (a length of one line in the X direction) (S1804). If the CPU 103 determines that the value of the width Loop counter is not equal to the rendering 1-line width (NO in S1804), the process advances to step S1805.

In step S1805, the CPU 103 compares the width Loop counter numerical value with the printing material reduction-inhibited width and also the width Loop counter numerical value with (printing material reduction-inhibited width C+printing material reducing width). If one of inequalities (width Loop counter numerical value<printing material reduction-inhibited width) and (width Loop counter numerical value>(printing material reduction-inhibited width C+printing material reducing width)) is satisfied, the CPU 103 determines YES (YES in S1805). If neither of these inequalities are satisfied, the CPU determines NO (NO in S1805).

If the CPU 103 determines NO in step S1805 (NO in S1805), it extracts if a pixel to be rendered corresponds to a black or white position in a thinning pattern shown in FIG. 15B (S1806). Then, the CPU 103 determines whether a pixel of the selected thinning pattern is ON (black) or OFF (white) (S1807). If the CPU 103 determines that the pixel of the selected thinning pattern is not ON (NO in S1807), it executes the thinning processing by applying white color data to that pixel (S1808). Then, the CPU 103 increments the width Loop counter (S1809). The process returns to step S1804 to check whether or not the value of the width Loop counter is equal to the rendering 1-line width (the length of one line in the X direction).

If the CPU 103 determines YES in step S1805 (YES in S1805), or if it determines in step S1807 that the pixel of the selected thinning pattern is ON (YES in S1807), it applies rendering data (Red, Green, Blue) associated with colors to the corresponding position based on the layout data created by the program of the layout data creation unit 104 (S1810). These rendering data indicate colors which are to be rendered and filled at that position. After step S1810, the CPU 103 increments the width Loop counter (S1809). Then, the process returns to step S1804 to check whether or not the value of the width Loop counter is equal to the rendering 1-line width (the length of one line in the X direction).

If the CPU 103 determines YES in step S1804 (YES in S1804), it ends the 1-line rendering data generation processing (S1811), and increments the height Loop counter (S1812). The process returns to step S1802, and the CPU 103 repeats the subsequent sequence until it is determined that the value of the height Loop counter is equal to the height of the N lines. If the CPU 103 determines that the value of the height Loop counter is equal to the height of the N lines (YES in S1802), it ends the printing material reducing N-line rendering data generation processing.

In step S1608 (FIG. 16A), the CPU 103 generates the printing material reducing D-line rendering data. In the method of generating the printing material reducing D-line rendering data by the CPU 103, a step of checking whether or not the height Loop counter is equal to D can be executed in place of step S1804 in FIG. 18A.

A case will be described below wherein the printing material reduction filling processing (steps S607, S610, and S616) in FIG. 6 is attained by the thinning processing. Upon execution of the thinning processing for text, line, and bitmap objects, the CPU 103 executes steps S1806, S1807, S1808, and S1810 in FIG. 18B in place of the process executed in step S1410 (FIG. 14), thus attaining the thinning processing. That is, if YES in step S1408 in FIG. 14, the CPU 103 executes step S1806, and then executes the checking process in step S1807. If YES in step S1807, the CPU 103 executes step S1810; otherwise, it executes step S1808. After step S1810 or S1808, the CPU 103 advances the process to step S1404.

Note that the normal filling processing is implemented in the thinning processing as well in case the CPU 103 executes the sequence shown in FIG. 13.

As for the density conversion and thinning processing of this embodiment, the user may be allowed to select whether to cause the information processing apparatus 100 to execute the density conversion or thinning processing on the selection window shown in FIG. 5.

As described above, according to this embodiment, the CPU 103 applies image processing (density conversion, thinning processing) for reducing printing materials to internal part data of a selected object except for its contour using the program of the printer driver 105. Then, since an object which is to undergo the printing material reduction can be selected, the printing material reduction can be skipped for an object to the internal part of which the user does not want to apply thinning processing.

According to the present invention, in case it is selected to execute the printing material reducing mode for reducing the amounts of applying printing materials to a printing medium, the processing unit applies image processing for reducing printing materials based on predetermined reduction data to data corresponding to an internal part of a designated partial image except for its contour. Then, the user can select an image for which the amounts of applying printing materials to a printing material are to be reduced. For this reason, the present invention can provide an image processing method and image processing apparatus, which are convenient for the user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-295864 filed on Dec. 25, 2009 and Japanese Patent Application No. 2010-234808 filed on Oct. 19, 2010, which are hereby incorporated by reference herein in their entirety.

What is claimed is:

1. An image processing method for processing an entire image including a plurality of partial images, comprising the step of:
selecting whether or not to execute a printing material reducing mode for reducing an amount of printing material applied to a printing medium;
designating a partial image for which the printing material reducing mode is executed in case the printing material reducing mode is selected;
applying image processing for reducing a printing material based on predetermined reduction data to data corresponding to an internal part except for a contour of the partial image designated in the designating step; and
outputting data corresponding to the entire image including the partial image processed in the applying step.

2. The method according to claim 1, further comprising:
designating a width of the contour of the partial image designated in the designating step.

3. The method according to claim 1, wherein the plurality of partial images which form the entire image have attributes according to types of the partial images, an attribute of a partial image is designated in the designating step, and the image processing is applied based on the predetermined reduction data to data corresponding to an internal part except for a contour of a partial image having the attribute designated in the designating step.

4. The method according to claim 3, wherein in the designating step, different attributes are allowed to be designated.

5. The method according to claim 1, wherein in the applying step, density conversion is applied.

6. The method according to claim 1, wherein in the applying step, thinning processing is applied.

7. An image processing apparatus for processing an entire image including a plurality of partial images, comprising:
a mode selection unit that selects whether or not to execute a printing material reducing mode for reducing an amount of printing material applied to a printing medium;
an image designation unit that designates a partial image for which the printing material reducing mode is executed in case said mode selection unit selects the printing material reducing mode;
a processing unit that applies image processing for reducing a printing material based on predetermined reduction data to data corresponding to an internal part except for a contour of the partial image designated by said image designation unit; and
a data output unit that outputs data corresponding to the entire image including the partial image processed by said processing unit,
wherein in case said mode selection unit selects not to execute the printing material reducing mode, said processing unit does not execute the image processing of the plurality of partial images.

8. The apparatus according to claim 7, further comprising:
a contour designation unit that designates a width of the contour of the partial image designated by said image designation unit.

9. The apparatus according to claim 7, wherein the plurality of partial images which form the entire image have attributes according to types of the partial images, said image designation unit designates an attribute of a partial image, and said processing unit applies the image processing based on the predetermined reduction data to data corresponding to an internal part except for a contour of a partial image having the attribute designated by said image designation unit, and does not apply the image processing to a partial image having an attribute which is not designated by said image designation unit.

10. The apparatus according to claim 9, wherein said image designation unit is allowed to designate different attributes.

11. The apparatus according to claim 7, wherein in case a partial image designated by said image designation unit consists only of a contour, said processing unit does not apply the image processing to that partial image.

12. The apparatus according to claim 7, wherein the image processing is density conversion.

13. The apparatus according to claim 7, wherein the image processing is thinning processing.
